(19) United States
(12) Patent Application Publication
(10) Pub. No.: US 2019/0188345 A1
(43) Pub. Date: Jun. 20, 2019

(54) METHOD FOR DIAGNOSING ROTATION DEVICE BY MEANS OF ROTOR-BEARING-FOUNDATION MODEL

(71) Applicant: KOREA HYDRO & NUCLEAR POWER CO., LTD., Gyeongsangbuk-do (KR)

(72) Inventors: Yang Seok Kim, Daejeon (KR); Dae Woong KIM, Sejong (KR); Bum Nyun KIM, Gyeongsangbuk-do (KR); Young Sheop PARK, Sejong (KR); Chi Yong PARK, Daejeon (KR); Jong Seog KIM, Daejeon (KR); Hyoung Kyun KIM, Daejeon (KR); Byoung Oh LEE, Daejeon (KR); Ji In KIM, Seoul (KR); Nam Woo CHOI, Gyeonggi-do (KR); Ji Soo RYU, Gyeongsangbuk-do (KR); Hee Seung CHANG, Daejeon (KR); You Soo SHIN, Gyeongsangbuk-do (KR)

(21) Appl. No.: 16/328,525

(22) PCT Filed: Aug. 29, 2017
(86) PCT No.: PCT/KR2017/009420

§ 371 Date: Feb. 26, 2019

(30) Foreign Application Priority Data
Aug. 29, 2016 (KR) 10-2016-0110314

(51) Int. Cl. G06F 17/50; G01M 13/04

(52) U.S. Cl. CPC G06F 17/5018; G06F 2217/16; G01M 13/04

(57) ABSTRACT

The present invention provides a method for diagnosing a rotation device by means of a rotor-bearing-foundation model, the method characterized by utilizing the characteristics of a simulation rotor system. To this end, the present invention comprises the steps of: simulating a rotation device as a rotor system; forming a mathematical model for the rotor system; estimating the state of the rotation device by means of the mathematical model and a vibration measurement value of the rotation device; and diagnosing for abnormalities in the rotation device from the changes in an estimated value. Therefore, since a rotation device is diagnosed for abnormalities by means of forming a mathematical model for a rotor system, the present invention enables more accurate diagnosis of the rotation device.

### TECHNICAL FIELD

The present invention relates to a method for diagnosing a rotation device by means of a rotor-bearing-foundation model and, more particularly, to a method for diagnosing a rotation device by means of a rotor-bearing-foundation model for diagnosing a rotation device provided in a power plant.

### BACKGROUND ART

Generally, a rotation device such as a turbine, a water supply pump, and the like is provided. In the rotation device, a monitoring system for safe operation of a power plant may be provided. The monitoring system monitors various types of variables including an axial vibration of a rotation device in real time, and generates a warning or stops generation when an abnormal situation occurs.

However, since a plant shutdown is critical in a power plant operation, a detailed diagnosis is performed with a diagnosing system provided with a diagnosing function. However, in the diagnosing function included in the conventional diagnosing system, a vibration measurement value is mainly used, and there is a problem that a physical property of a rotation device is not considered.

### DISCLOSURE

### Technical Problem

An object of the present invention is to provide method for diagnosing a rotation device by means of a rotor-bearing-foundation model, the method characterized by utilizing the characteristics of a simulation rotor system.

### Technical Solution

A method for diagnosing a rotation device by means of a rotor-bearing-foundation model according to the present invention comprises simulating a rotation device as a rotor system, forming a mathematical model for the rotor system, estimating a state of the rotation device by means of the mathematical model and a vibration measurement value of the rotation device, and diagnosing for abnormalities in the rotation device from the changes in an estimated value.

The rotor system may be simulated as a foundation comprising a rotor, a journal bearing and a bearing housing.

The step of forming the mathematical model may comprise calculating a parameter of the rotor by using finite element method and calculating a parameter of the journal bearing based on Reynolds Equation.

The step of forming the mathematical model may use finite difference method as a method for obtaining an approximation solution of the journal bearing model.

A parameter of the rotor system may comprise at least one of mass, stiffness and damping coefficient.

The step of forming the mathematical model may further comprise calculating a parameter of the rotation device foundation by using increasing speed data of the rotation device.

The step of estimating a state of the rotation device may estimate at least one of an external force exerted on the journal bearing and a bearing dynamic coefficient based on a rotation axis vibration displacement of the rotor system and a vibration acceleration measurement value of the bearing housing.

### Advantageous Effects

According to a method for diagnosing a rotation device by means of a rotor-bearing-foundation model according to the present invention, an abnormal state of a rotation device is diagnosed by constructing a mathematical model for a rotor system, and there is an effect that more accurate diagnosis of a rotation device is available.

The technical effects in the present invention are not limited to the above-described technical effects and other technical effects which are not described herein will become apparent to those skilled in the art from the following description.

### DESCRIPTION OF DRAWINGS

FIG. 1 is a flowchart illustrating a method for diagnosing a rotation device by means of a rotor-bearing-foundation model according to an embodiment;

FIG. 2 is a conceptual diagram illustrating journal bearing dynamic coefficients according to an embodiment;

FIG. 3 is a flowchart for calculating journal bearing dynamic coefficients using finite difference method according to an embodiment; and

FIG. 4 is a conceptual diagram illustrating a rotor-bearing-foundation system according to an embodiment.

### MODE FOR INVENTION

Hereinafter, embodiments of the present invention are described in detail with reference to accompanying drawings. However, the embodiments are not limited to the embodiment described below, but may be implemented in various forms, and the embodiments are provided to inform the scope of the invention perfectly to those ordinary skilled in the art by perfecting the description of the present invention. Some parts of a shape or the like of an element in the drawing may be exaggerated for clear description, and an element denoted by the same reference numeral means the same element.

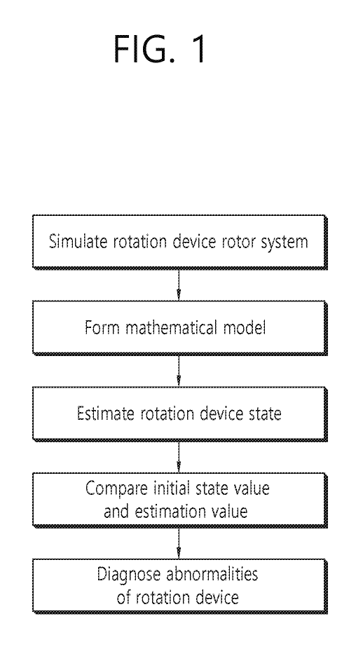

FIG. 1 is a flowchart illustrating a method for diagnosing a rotation device by means of a rotor-bearing-foundation model according to an embodiment.

As shown in FIG. 1, in the method for diagnosing a rotation device according to the embodiment, a rotation device may be simulated as a rotor system.

In the rotor system, various types of forces are exerted during an operation. These forces may be distinguished as a lateral direction, an axial direction and a rotational direction according to an exerted direction. And, the forces may be distinguished as a static force which is uniform for a time and a dynamic force of which magnitude and direction are changed.

At this time, the dynamic force causes a lateral and axial directional vibration of an axis, a torsional vibration, and the like. Here, the rotor system has a property like a black box that output a vibration when the dynamic force is exerted. When such a property like a black box is closely understood, a device state may be understood on which force causes a vibration in the rotor system.

The vibration of a rotation axis in the rotor system means a proportion of an external force for Dynamic Stiffness. This means that two causes are existed in increasing a magnitude of the vibration. One of the two causes is that a magnitude of the external force is increased, and another of the two causes is that a performance of the rotor system is degraded and dynamic stiffness becomes weak. Accordingly, for diagnosis, it is importance to detect a change of the external force exerted on a system and an internal parameter, for example, the dynamic stiffness.

Such a block box property may be estimated by developing a mathematical model for the rotor system. Here, a proper mathematical model enables to predict an influence on a vibration caused by a change of force. Such a property is very importance factor even in the case of diagnosing a device.

Accordingly, in the rotor system, a rotation device may be briefly simulated as a foundation including a rotor, a journal bearing and a bearing housing. In addition, a mathematical model for the rotor system may be constructed.

A rotor-journal bearing-foundation model, which is a mathematical model, is described as below. Since a diameter is smaller than a length in most of rotors, first, the rotor system is modeled to be a rotating beam to which one or more disks are attached. And, the entire model is constructed in a method of combining a journal bearing model with a foundation model. Here, parameters of a rotor, a journal bearing and a foundation, which are included in the rotor system, may include at least one of mass, stiffness and damping coefficient.

Here, the parameters (mass, stiffness and damping coefficient) of the rotor included in the rotor system model is calculated by using finite element method. And, in order to consider an influence of hydrodynamic lubrication influenced on a rotor behavior, the parameters (stiffness and damping coefficient) of the journal bearing is obtained by using the journal bearing model based on Reynolds Equation. Here, finite difference method may be used for a method of obtaining an approximate solution of the journal bearing model.

In addition, the foundation parameters (mass, stiffness and damping coefficient) included in the rotor-journal bearing-foundation model are obtained by using increasing speed(speed up) data of the rotation device. And, at this time, an initial external force, for example, a miss alignment or an unbalance value is simultaneously estimated, and used as a diagnostic reference value.

As such, when the rotor, the rotor-journal bearing and the foundation parameters are determined, the parameters are not changed so long as there is no abnormality in the rotation device itself, and the change of external force may be estimated by using the rotor-journal bearing-foundation model and a vibration acceleration measurement value of the bearing housing. And, an abnormality state of the rotation device may be diagnosed by comparing the estimated value with the external force estimated value.

In addition, by using the initial external force and the vibration displacement estimation value of the rotation axis, a parameter of the journal bearing may be obtained, and the abnormality state of the rotation device may be diagnosed by comparing it with the initial external force.

Here, in describing the journal bearing model according to the present invention, the property of the journal bearing is classified into a property of static stable state and a property of dynamic state, generally.

At this time, the static property may include Sommerfeld Number, an orientation angle, a frictional loss, and the like. And, the representative dynamic property is known by 8 dynamic coefficients (stiffness and damping coefficient), and such properties may be calculated by using a geometrical shape of the bearing. Particularly, the dynamic coefficients related to oil film is the main property of the journal bearing, and these coefficients influence on a dynamic behavior of the rotor-bearing system significantly. In addition, the bearing force, which means a binding force exerted on the journal bearing by the bearing oil film, is a function of a position of the journal and a velocity, and may be represented by using 8 dynamic coefficients and a displacement (x, y).

$$\begin{matrix}{F}_{x} = {k}_{xx} x + {k}_{xy} y + {c}_{xx} {W}_{x} + {c}_{xy} {W}_{y} & [ Equation 1 ] \\ {F}_{y} = {k}_{yx} x + {k}_{yy} y + {c}_{yx} {W}_{x} + {c}_{yy} {W}_{y} & [ Equation 2 ]\end{matrix}$$

Herein, Fₓ and F_{y} are bearing forces in x and y directions, respectively, and the definition of 8 dynamic coefficients is as below.

$$\begin{matrix}{k}_{xx} = \frac{{BF}_{x}}{Bx} , {k}_{xy} = \frac{{BF}_{x}}{By} , \\ {k}_{yx} = \frac{{BF}_{y}}{Bx} , {k}_{yy} = \frac{{BF}_{y}}{By} & [ Equation 3 ] \\ {c}_{xx} = \frac{{BF}_{x}}{{BW}_{x}} , {c}_{xy} = \frac{{BF}_{x}}{{BW}_{y}} , \\ {c}_{yx} = \frac{{BF}_{y}}{{BW}_{x}} , {c}_{yy} = \frac{{BF}_{y}}{{BW}_{y}} & [ Equation 4 ]\end{matrix}$$

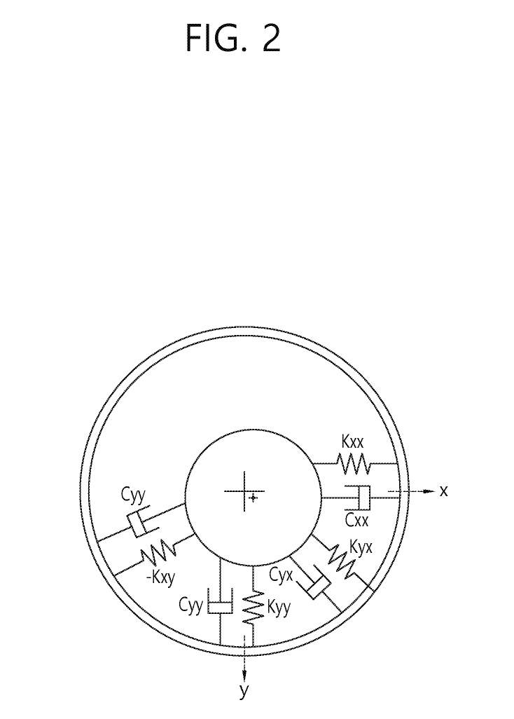

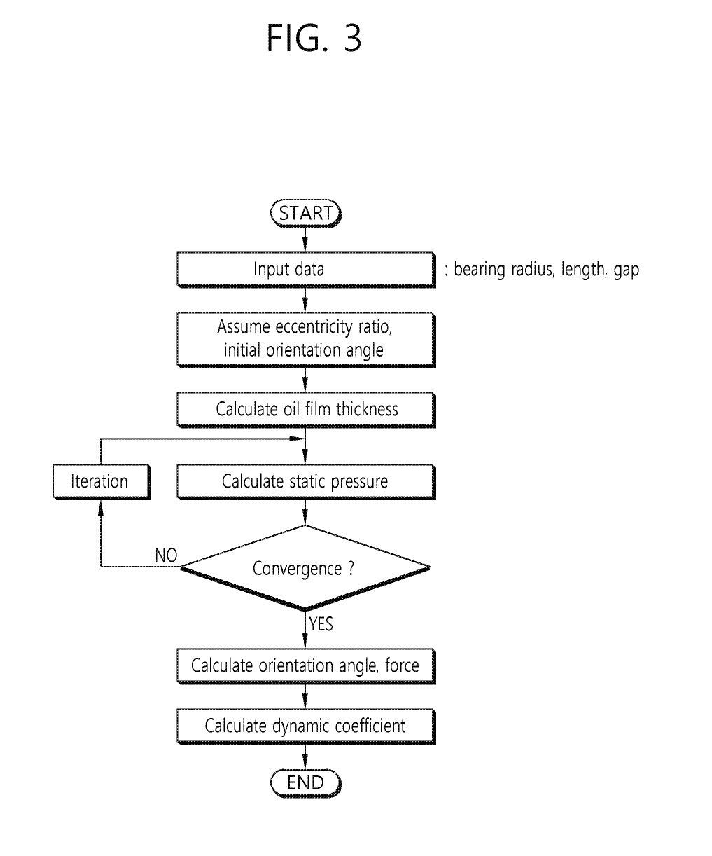

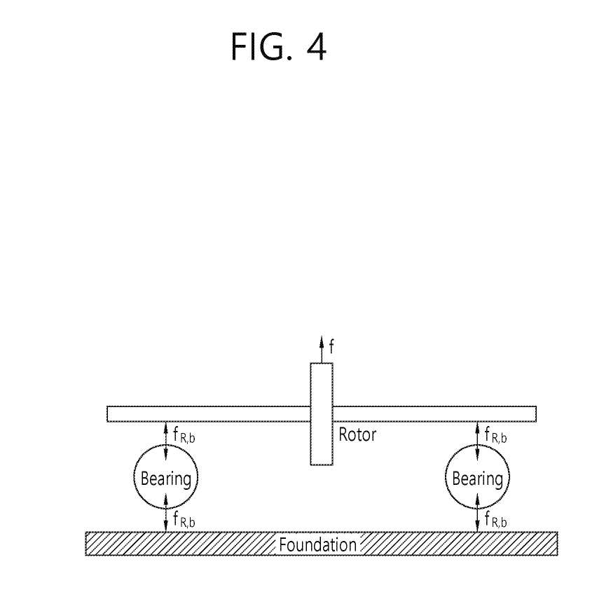

Meanwhile, FIG. 2 is a conceptual diagram illustrating journal bearing dynamic coefficients according to an embodiment, and FIG. 3 is a flowchart for calculating journal bearing dynamic coefficients using finite difference method according to an embodiment. And, FIG. 4 is a conceptual diagram illustrating a rotor-bearing-foundation system according to an embodiment.

As shown in FIG. 2 and FIG. 3, the dynamic coefficients of journal bearing are dominant in the dynamic performance of a rotor bearing system, and very importance in kinetic analysis. Since a programming and an understanding the finite difference method are not so difficult, the finite difference method is used for solving Reynolds Equation, generally. FIG. 3 is a flowchart for calculating the journal bearing dynamic coefficients from Reynolds Equation and the journal bearing model constructed by Equations 1 to 4 using finite difference method.

Here, the rotor-journal bearing-foundation model is described in detail. FIG. 4 depicts the concept of the rotor-journal bearing-foundation system schematically, and the equation of motion of the rotor-journal bearing-foundation system is as represented in Equation 5 below.

Here, Z of Equation 5 is a Dynamic stiffness matrix constructed by mass, damping and stiffness value. And, subscripts b and i represent degree of freedoms of a bearing and an internal connection point, respectively. F, R and B mean a foundation, a rotor and a bearing. r is a response and [symbol] is a combination of a force exerted owing to unbalance and a force owing to miss alignment.

Here, in the case that a measurement is performed only on a position of the bearing, the term r_{Fi} may be removed, and the foundation parameter may be simplified as

Z̅_̅{̅F̅}̅=Z_{F,bb}−Z_{F,bi}Z_{F,ii}⁻¹Z_{F,ib}

Accordingly, since this corresponds to r_{R,i}=Z_{R,ii}⁻¹{f−Z_{R,ib}r_{R,b}} from the first column of Equation 5, Equation 5 may be simply represented as Equation 6 below.

$$[ \begin{matrix}P - {Z}_{B} \\ - {Z}_{B} {Z}_{B} + {Z}_{F}\end{matrix} ] \{ \begin{matrix}{r}_{R , b} \\ {r}_{F , b}\end{matrix} \} = \{ \begin{matrix}- {Z}_{R , bi} {Z}_{R , ii}^{- 1} f \\ 0\end{matrix} \} \qquad [ Equation 6 ]$$

Herein, P=Z_{R,bb}+Z_{B}−Z_{R,bi}Z_{R,ii}⁻¹Z_{R,ib}. If there is r_{F,b} which is a value measured in a bearing support structure, r_{R,b} may be represented by using r_{F,b} in Equation 6, and Equation 6 may be represented as Equation 7 below.

Z̅_{F}r_{F,b}+Z_{B}P⁻¹Z_{R,bi}Z_{R,ii}⁻¹f=Z_{B}[P⁻¹Z_{B}−I]r_{F,b} [Equation 7]

Accordingly, the foundation model, that is, the unknown quantities in Equation 7 are Z̅_̅{̅F̅}̅ and force [symbol] , and the other values may be obtained by using the rotor-bearing model and the vibration acceleration measurement value in the bearing housing.

In Equation 5 to Equation 7, the force vector [symbol] defined by a combination of the force exerted owing to unbalance and the force owing to miss alignment may be represented as Equation 8 below.

f=fᵤₙ+fₘ [Equation 8]

Herein, fᵤₙ is an unbalance vector, and fₘ is a vector of coupling force and moment, and may be denoted by Equations 9 and 10 below.

fᵤₙ=ω²Te [Equation 9]

fₘ=Tₘeₘ [Equation 10]

Herein, T is a matrix for selecting a surface on which unbalance is existed, e is a parameter vector related to unbalance of the rotor. Tₘ in is a matrix indicating a coupling position, and eₘ is a vector constructed by force and moment of vertical and horizontal directions in a coupling joint m. Accordingly, when Equations 8 to 10 are substituted to Equation 7, this is represented as Equation 11 below.

$${\overline{Z}}_{F} {r}_{F , b} + {Z}_{B} {P}^{- 1} {Z}_{R , bi} {Z}_{R , ii}^{- 1} [ {ω}^{2} {TT}_{m} ] \{ \begin{matrix}e \\ {e}_{m}\end{matrix} \} = {Z}_{B} [ {P}^{- 1} {Z}_{B} - I ] {r}_{F , b} \qquad [ Equation 11 ]$$

Herein, when a vector including all of mass, stiffness and damping coefficient of foundation parameter Z̅_̅{̅F̅}̅ which is unknown is denoted as v, and a response vector constructed by responses measured in each frequency is denoted as W, Z̅_{F}r_{F,b}=Wv. Equation 11 is rewritten for angular velocity ω as Equation 12 below.

$$[ W ( ω ) R ( ω ) {R}_{m} ( ω ) ] \{ \begin{matrix}v \\ e \\ {e}_{m}\end{matrix} \} = Q ( ω ) \qquad [ Equation 12 ]$$

Herein, W,R,Rₘ and Q simplifies the terms in the Equation, and Equation 12 is a function of each frequency component. By using Equation 12 and the vibration data measured in increasing speed duration, v,e,eₘ may be obtained. In addition, from these values, the foundation parameter and the initial external force may be estimated. In the case that the foundation parameter and the initial external force are determined, subsequently, the change of the external force such as unbalance, miss alignment, and the like may be estimated in real time by using the vibration data measured when the rotation device is driving. Furthermore, in the case that there is no change in the external force, the force exerted on the bearing and the change of the bearing dynamic coefficient may be estimated in real time, and accordingly, a performance change of the bearing may be diagnosed.

Therefore, according to a method for diagnosing a rotation device by means of a rotor-bearing-foundation model according to the present invention, an abnormal state of a rotation device is diagnosed by constructing a mathematical model for a rotor system, and there is an effect that more accurate diagnosis of a rotation device is available.

An embodiment of the present invention described above and depicted in the drawing should not be interpreted to limit the technical concept of the present invention. The scope of the present invention is limited only by the features defined in the claims, and those skilled in the art may improve or modify the technical concept of the present invention in various forms. Accordingly, the improvement and modification belongs to the scope of the present invention so long as the improvement and modification are obvious to those skilled in the art.

1. A method for diagnosing a rotation device by means of a rotor-bearing-foundation model, the method comprising:
simulating a rotation device as a rotor system;
forming a mathematical model for the rotor system;
estimating a state of the rotation device by means of the mathematical model and a vibration measurement value of the rotation device; and
diagnosing for abnormalities in the rotation device from the changes in an estimated value.

2. The method for diagnosing a rotation device by means of a rotor-bearing-foundation model of claim 1, wherein the rotor system is simulated as a foundation including a rotor, a journal bearing and a bearing housing.

3. The method for diagnosing a rotation device by means of a rotor-bearing-foundation model of claim 2, wherein the step of forming the mathematical model comprises:
calculating a parameter of the rotor by using finite element method; and
calculating a parameter of the journal bearing based on Reynolds Equation.

4. The method for diagnosing a rotation device by means of a rotor-bearing-foundation model of claim 3, wherein the step of forming the mathematical model uses finite difference method as a method for obtaining an approximation solution of the journal bearing model.

5. The method for diagnosing a rotation device by means of a rotor-bearing-foundation model of claim 3, wherein a parameter of the rotor system comprises at least one of mass, stiffness and damping coefficient.

6. The method for diagnosing a rotation device by means of a rotor-bearing-foundation model of claim 3, wherein the step of forming the mathematical model further comprises:
calculating a parameter of the rotation device foundation by using increasing speed data of the rotation device.

7. The method for diagnosing a rotation device by means of a rotor-bearing-foundation model of claim 1, wherein the step of estimating a state of the rotation device estimates at least one of an external force exerted on the journal bearing and a bearing dynamic coefficient based on a rotation axis vibration displacement of the rotor system and a vibration acceleration measurement value of the bearing housing.
